(19) United States
(12) Patent Application Publication
(10) Pub. No.: US 2004/0243366 A1
(43) Pub. Date: Dec. 2, 2004

(54) Method for optimal search on a technology landscape

(75) Inventors: Stuart A. Kauffman, Santa Fe, NM (US); Jose Lobo, Ithaca, NY (US); William G. MacReady, Santa Fe, NM (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Bios Group, Inc., Santa Fe, NM

(21) Appl. No.: 10/845,922

(22) Filed: May 14, 2004

Related U.S. Application Data
(63) Continuation of application No. 09/794,017, filed on Feb. 28, 2001.
Application No. 09/794,017 is a continuation of application No. PCT/US99/19916, filed on Aug. 31, 1999.
(60) Provisional application No. 60/098,591, filed on Aug. 31, 1998.
(60) Provisional application No. 60/098,581, filed on Aug. 31, 1998.

(51) Int. Cl. G06F 17/10

(52) U.S. Cl. 703/2

(57) ABSTRACT

Technological change at the firm-level has commonly been modeled as random sampling from a fixed distribution of possibilities. Such models, however, typically ignore empirically important aspects of the firm's search process, notably the observation that the present state of the firm guides future innovation. In this paper we explicitly treat this aspect of the firm's search for technological improvements by introducing a “technology landscape” into an otherwise standard dynamic programming setting where the optimal strategy is to assign a reservation price to each possible technology. Search is modeled as movement, constrained by the cost of innovation, over the technology landscape. Simulations are presented on a stylized technology landscape while analytic results are derived using landscapes that are similar to Markov random fields. We find that early in the search for technological improvements, if the initial position is poor or average, it is optimal to search far away on the technology landscape; but as the firm succeeds in finding technological improvements it is optimal to confine search to a local region of the landscape. We obtain the result that there are diminishing returns to search without having to make the assumption that the firm's repeated draws from the search space are independent and identically distributed.

### CROSS REFERENCE TO RELATED APPLICATIONS

This application is a continuation of the U.S. national phase designation of PCT application no. PCT/US99/19916, filed Aug. 31, 1999, the entire content of which is expressly incorporated herein by reference thereto. This PCT application claimed priority to U.S. provisional application No. 60/098,591, filed Aug. 31, 1998, the entire content of which is expressly incorporated herein by reference thereto.

### FIELD OF THE INVENTION

The present invention relates generally to methods for finding an optimal solution on a technology landscape. More specifically, the present invention finds an optimal production recipe by determining an optimal sampling distance from a current production recipe and by searching for a production recipe having a higher efficiency at the optimal sampling distance.

### BACKGROUND

Technological change has often been modeled by economists as a random search within a fixed population of possibilities (see e.g. Adams and Sveikauskas (1993), Cohen and Levinthal (1989), Evenson and Kislev (1976), Hey (1982), Jovanovic and Rob (1990), Levinthal and March (1981), Marengo (1992), Muth (1986), Nelson and Winter (1982), Tesler (1982), and Weitzman (1979)). Another body of work, both empirical and theoretical, emphasizes the importance of firm specific characteristics for explaining technological change (for empirical contributions to this literature, see e.g. Audretsch (1991, 1995), Bailey, Bartelsman and Haltinwanger (1994), Davis and Haltiwanger (1992), Dunne, Haltiwanger and Troske (1996), Dunne, Roberts and Samuelson (1988, 1989) and Dwyer (1995); for theoretical contributions, see e.g. Ericson and Pakes (1995), Herriott, Levinthal and March (1985), Hopenhayn (1992), Jovanovic (1982) and Kennedy (1994)). In this paper we seek to combine both points of view by addressing the question of how a firm's current production practices and its location in the space of technological possibilities constraint the firm's search for technological improvements. We are particularly interested in the relationship between the firm's current location in the space of technological possibilities and how far away from that location should the firm search for technological improvements.

The starting point for our discussion is the representation of technology and the model of a technology landscape first presented in Auerswald and Lobo (1996) and Auerswald, Kauffman, Lobo and Shell (1998). In this modeling framework, a firm's production plan is more than a point in input-output space; it also includes the production recipe used in the process of production. A configuration denotes a specific assignment of states for every operation in the production recipe. A production recipe is comprised of N distinct operations, each of which can occupy one of S discrete states. The productivity of labor employed by a firm is a summation over the labor efficiency associated with each of the N production operations. The labor efficiency of any given operation is dependent on the state that it occupies, as well as the states of e other operations. The parameter e represents the magnitude of production externalities among the N operations comprising a production recipe, what we refer to as “intranalities.”

In the course of production during any given time period, the state of one or more operation is changed as a result either of spontaneous experimentation or strategic behavior. This change in the state of one or more operations of the firm's production recipe alters the firm's labor efficiency. The firm improves its labor efficiency—that is to say, the firm finds technological improvements—by searching over the space of all possible configurations for its production recipe. When a firm finds a more efficient production recipe, it adopts that recipe in the next production period with certainty. The firm's search for more efficient, production recipes is studied here as a “walk” on a technology landscape. The distance metric on the technology landscape is defined by the number of operations whose states need to be changed in order to turn one configuration into another. The cost of search paid by the firm when sampling a new configuration is a nondecreasing function of the number of operations in the newly sampled configuration whose states differ from those in the currently utilized production recipe.

We are particularly interested in the determination of the optimal distance (given our distance metric) at which a firm should sample new production recipes. The literatures on technology management and organizational behavior emphasize that although firms employ a wide range of search strategies, firms tend to engage in local search—i.e., search that enables firms to build upon their established technology (see, e.g. Barney (1991), Boeker (1989), Helfat (1994), Henderson and Clarke (1990), Lee and Allen (1982), Sahal (1985), Shan (1990), Stuart and Podolny (1996) and Tushman and Anderson (1986)). As discussed in March (1991) and Stuart and Podolny (1996), the prevalence of local search stems from the significant effort required for firms to achieve a certain level of technological competence, as well as from the greater risks and uncertainty faced by firms when they search for innovations far away from their current location in the space of technological possibilities. Using both numerical and analytical results we relate the optimal search distance to the firm's initial productivity, the cost of search, and the correlation structure of the technology landscape. As a preview of our main result, we find that early in the search for technological improvements, if the firm's initial technological position is poor or average, it is optimal to search far away on the technology landscape. As the firm succeeds in finding technological improvements, however, it is optimal to confine search to a local region of the technology landscape. We thus obtain the familiar result that there are diminishing returns to search but without having to make the assumption, typically in the search literature, that the firm's repeated draws from the search space are independent and identically distributed.

### SUMMARY OF THE INVENTION

The present invention presents a method for finding an optimal production recipe by determining an optimal sampling distance from a current production recipe and by searching for a production recipe having a higher efficiency at the optimal sampling distance.

It is an aspect of the present invention to present a method for improving a current production recipe, ωᵢ, comprising the steps of:

defining a space of a plurality of production recipes, Ω;

defining a distance, d, between two of said plurality of production recipes ω_{i,} ωⱼ∈Ω;

defining an efficiency for at least one of said plurality of production recipes;

determining an optimal sampling distance, d*, from the current production recipe ω_{i,}; and

searching at said optimal sampling distance d* from the current production recipe ω_{i,} for at least one new production recipe ω_{j,} wherein the efficiency of said new production recipe ω_{j,} is greater than the efficiency of the current production recipe ω_{i,}.

### BRIEF DESCRIPTION OF THE DRAWINGS

FIG. 1 shows mean labor efficiencies ±one standard deviation versus search distance for N=100, e=1 and three different initial labor efficiencies.

FIG. 2 shows mean labor efficiencies ±one standard deviation versus search distance for N=100, e=5 and three different initial labor efficiencies.

FIG. 3 shows mean labor efficiencies ±one standard deviation versus search distance for N=100, e=11 and three different initial labor efficiencies.

FIG. 4 shows optimal search distance d* as a function of the search cost α and the initial labor efficiency θ(ω) for a landscape with nearest-neighbor correlation coefficient of p=0.3.

FIG. 5 shows optimal search distance d* as a function of the search cost α and the initial labor efficiency θ(ω) for a landscape with nearest-neighbor correlation coefficient of p=0.6.

FIG. 6 shows optimal search distance d* as a function of the search cost α and the initial labor efficiency θ(ω) for a landscape with nearest-neighbor correlation coefficient of p=0.9.

### DETAILED DESCRIPTION OF THE PREFERRED EMBODIMENT

The outline of the description of the preferred embodiment is as follows. Section 1.1 presents a simple model of firm-level technology; production recipes are introduced in Section 1.1 and production “intranalities” are defined in Section 1.2 and firm level technological change is discussed in Section 1.3. Section 2 develops the notion of a technology landscape, which is defined in Section 2.1. The correlation structure of the technology landscape is introduced, in Section 2.2, as an important characteristic defining the landscape. Section 3 treats the firm's search for improved production recipes as movement on it's technology landscape. The cost of this search is considered in Section 3.1. Section 3.2 then presents simulations results of search for the Ne technology landscape model defined in Section 1.2. We then go on to develop an analytically tractable model of technology landscapes in Section 4. We also describe in this section how a landscape can be represented by a probability distribution under an annealed approximation. Section 5 considers search under this formal model. The firm's search problem is formally defined in Section 5.1 and the important role of reservation prices is considered in Section 5.2. Section 5.3 determines the reservation price which determines optimal search and results are presented in Section 5.4. We conclude in Section 6 with a summary of results.

1 Technology

1.1 Production Recipes

A firm using production recipe w and labor input lₜ produces qₜ units of output during time period t:

qₜ=F[θₜ,lₜ]. (1)

The parameter θ represents a cardinal measure of the level of organizational capital associated with production recipe ω. The material in Sections 1 and 2 draws heavily from Auerswald and Lobo (1996) and Auerswald, Kauffman, Lobo and Shell (1998). The firm's level of organizational capital determines the firm's labor productivity (i.e., how much output is produced by a fixed amount of labor). Firm-level output is thus an increasing function of organizational capital, θ. A firm's level of organizational capital is a function of the production recipe utilized by the firm. The firm's production recipe encompasses all of the deliberate organizational and technical practices which, when performed together, result in the production of a specific good. Our concept of organizational capital is very similar to that found in Prescott and Visscher (1980) and Hall (1991). We assume, however, that production recipes as we define them are not fully known even to the firms which use them, much less to outsiders looking in. In order to allow for a possibly high-level of heterogeneity among production recipes utilized by different firms, we posit the existence of a set of all possible production recipes, Ω. We will refer to a single element ωᵢ ∈Ω as a production recipe. The efficiency mapping:

θ:ωᵢ∈Ω→ [symbol] ⁺⁺ ( 2)

associates each production recipe with a unique labor efficiency.

Production recipes are assumed to involve a number of distinct and well defined operations. Denote by N the number of operations in the firm's production recipe, which is determined by engineering considerations. The ith recipe ωᵢ can then be represented by

ωᵢ={ωᵢ¹, . . . , ωᵢ^{j}, . . . ,ωᵢ^{N}, . . . }, (3)

where ωᵢ^{j} is the description of operation j for j=1, . . . , N. We assume that the operations comprising a production recipe can be characterized by a set of discrete choices. These discrete choices may represent either qualitative choices (e.g. whether to use a conveyor belt or a forklift for internal transport), quantitative choices (e.g. the setting of a knob on a machine), or a mixture of both. In particular we assume that

ωᵢ^{j}∈{1, . . . S} (4)

obtains for i ∈{1, . . . , N} and where S is a positive integer. Each operation ωᵢ^{j} of the production recipe ωᵢ^{j} can thus occupy one of S states.

We denote a specific assignment of states to each operation in a production recipe as a configuration. Making the simplifying assumption that the number of possible states is the same for all operations that comprise a given production recipe, the number of all possible and distinct configurations for a given production recipe associated with a specific good is equal to:

|Ω|=S^{N}. (5)

New production processes are created by altering the states of the operations which comprise a production recipe. Technological change in this framework takes the form of finding production recipes which maximize labor efficiency per unit of output (i.e., technological progress is Harrod-neutral).

The contribution to overall labor efficiency made by the jth operation depends on the setting or state chosen for that operation, ωᵢ^{j}, and possibly on the settings chosen for all other operations, ωᵢ^{-j}. Hence the labor efficiency of the jth operation is in general a function φᵢ^{j} of ωᵢ^{j} and ωᵢ^{-j}, so that we can write

φᵢ^{j}=φ^{j}(ωᵢ^{j},ωᵢ^{-j}). (6)

More specifically, but without loss of generality, we assume that the N distinct operations that comprise the production recipe contribute additively to the firm's labor efficiency:

$$θ ( {ω}_{i} ) = \frac{1}{N} {\sum }_{j = 1}^{N} {Φ}^{j} = \frac{1}{N} {\sum }_{j = 1}^{N} {Φ}^{j} ( {ω}_{i}^{j} , {ω}_{i}^{- j} ) . \qquad ( 7 )$$

We can think of φ^{j}(ωᵢ^{j},ωᵢ^{-j}) as the payoff to the jth operating unit when it is in state ω^{j} and the other operations are in the states encoded by the vector ω^{-j}. In our cooperative setting, operations act not to maximize their own labor efficiency, but rather the aggregate labor productivity of the firm (i.e., θ(ωᵢ)).

1.2 Production Intranalities

Working from the view that an important role of the firm is to “internalize” externalities (Coase (1937), Williamson (1985)), we assume that in the typical case there are significant external economies and diseconomies among the N operations comprising a production recipe—that is to say, significant production and management externalities exist within the firm. These “intranalities” can be thought of as connections between the operations constituting the production recipe (Reiter and Sherman (1962)). To say that a connection exists between two operations is simply to say that the performance of the two operations affect each other (positively or negatively) either bilaterally or unidirectionally.

For a production recipe ωεΩ, we define the production intranality scalar

eₖ^{j}=e(ω^{k},ω^{j}), (8)

as follows:

$${e}_{k}^{j} = \{ \begin{matrix}1 & \begin{matrix}if the setting of operation j affects the \\ labor requirement of operation k\end{matrix} \\ 0 & otherwise\end{matrix} \qquad ( 9 )$$

for j, k=1, . . . N. Since the choice of the setting for the jth operation always affects the cost for the jth operation, we have

eⱼ^{j}=1 (10)

for j=1, . . . , N. The number of operations whose costs are affected by the jth operation, e^{j}, is given by

$${e}^{j} = {\sum }_{k = 1}^{N} {e}_{k}^{j} \qquad ( 11 )$$

for j, k=1, . . . , N, while the number of operations that affect the costs of operation j, eⱼ, is given by

$${e}_{j} = {\sum }_{k = 1}^{N} {e}_{j}^{k} \qquad ( 12 )$$

for j, k=1, . . . , N. We make the strong simplifying assumption of equal number of connections, namely

e^{j}=eⱼ=e (13)

for j=1, . . . , N. The parameters N and e are directly analogous to the parameters N and K in Kauffman's NK model of fitness landscapes (Kauffman and Levin (1987), Kauffman (1993)). We assume throughout that e and N are given by nature.

When e=1, equation (8) is additively separable, otherwise

$$θ ( {ω}_{i} ) = \frac{1}{N} {\sum }_{j = 1}^{N} {Φ}^{j} = \frac{1}{N} {\sum }_{j = 1}^{N} {Φ}^{j} ( {ω}_{i}^{j} , {ω}_{i}^{{j}_{1}} , … , {ω}_{i}^{{j}_{e}} ) . \qquad ( 14 )$$

The S^{e} possible contributions to total labor efficiency made by the jth operation (through φ^{j}) are treated as i.i.d. random variables drawn from some distribution F. In what follows we assume that the values returned by φ are drawn from the Uniform distribution, U (0, 1), over the unit interval, although out results are insensitive to this choice.

1.3 Firm-Level Technological Change

We can now describe the general features of the technological problem facing the firm in our model. The firm's production recipe determines the firm's level of organizational capital and thus its labor efficiency. The production recipe is comprised of a number of distinct operations which at each moment can be in one of a finite number of possible, and discrete, states. Consequently, improvements in the technology used by the firm entails changes in the state of the operations comprising the production recipe. Our view of technological innovation is similar to that of Romer (1990), who remarks that over the past few hundred years, “the raw materials that we use have not changed, but as a result of trial and error, experimentation, refinement and scientific investigation, the instructions that we follow for combining raw materials have become vastly more sophisticated.” Our “production recipes” are directly analogous to Romer's “instructions.” Firm-level technological improvements result from the firm finding improved configurations for its production recipe. Thus stated, the firm's technological problem is a combinatorial optimization problem (Sherman and Reiter (1965), Papadimitriou and Steiglitz (1982), Cameron (1994)). A compelling question to ask in the context of combinatorial optimization is whether the globally optimal configuration can be reached from any given initial configuration.

We propose to study the firm's technological problem by means of a technology landscape, developed in the next section. The economies or diseconomies resulting from the interaction among the operations constituting the production recipe constraint the firm's search for technological improvements. The intranalities parameter e provides a measure of the conflicting constraints confronting the firm as it seeks to optimize its production recipe. Just as a topographical map is a way of representing constraints on movement over a 3-dimensional physical space, a technology landscape is a means of representing constraints on the firm's search for the optimal configuration for its production recipe.

2 The Technology Landscape

2.1 Defining the Technology Landscape

In order to define a technology landscape we first need to have a measure of distance between two different production recipes, ωᵢ and ωⱼ, each drawn from Ω. The distance metric used here is not based on the relative efficiencies of production recipes, but rather on the similarity between the operations constituting the recipes. More precisely, the distance d(ωᵢ,ωⱼ) between the production recipes ωᵢ, and ωⱼ is the minimum number of operations which must be changed in order to convert ωᵢ to ωⱼ. Since changing operations is symmetric, we have that d(ωᵢ,ωⱼ)=d(ωⱼ,ωᵢ). Given this distance metric, we can define the set of “neighbors” for any production recipe: let N_{d}(ωᵢ) denote the set of d-neighbors of recipe ωⁱ,

N_{d}(ωᵢ)={ωⱼ∈{Ω−ωᵢ}:d(ωᵢ,ωⱼ)=d}, (15)

where d ∈{0, . . . , N}.

With this definition of distance between recipes, it is straightforward to construct the technological graph Γ(V, E). The set of nodes or vertices of the graph, V, are the production recipes ωᵢ ∈Ω. The set of edges of the technological graph, E, connect any given recipe to its d=1 neighbors, i.e. to the elements of N₁ (ωᵢ). For any production recipe, the number of one operation variant neighbors is given by:

N₁(ωᵢ)=(S−1)N for all ωᵢ ∈Ω. (16)

Thus each node of Γ is connected to (S−1) N other nodes.

Assume, for the moment, that the labor efficiencies θ(ωᵢ) are known with certainty for each ωᵢ εΩ. Adopting some method for tie-breaking, we can orient the edges of the graph Γ from vertices with higher labor efficiencies toward vertices associated with lower labor efficiencies. The resulting directed graph is a Technology Landscape, L, in which production recipes connected by an edge differ in the setting or state of exactly one operation. A landscape is therefore a mapping from elements in a finite metric space into the real numbers. For a comprehensive discussion of landscape models see Jones (1994) and Stadler (1995). The firm's problem can then be recast as that of “moving” in the technology landscape (varying the production recipe by changing the state of at least one operation) in order to maximize θ. This is roughly equivalent to solving the combinatorial optimization problem of maximizing an objective function defined on the vertices of an N-dimensional cube by employing a “hill-climbing algorithm” (Tovey 1985). The “steps” constituting such a walk represent the adoption, by the firm, of the sampled variants for its production recipe.

In the more general (and interesting) case where the efficiency θ(ω) associated with each production recipe is not known with certainty, a random field, [symbol] , can be defined over the production recipes ω∈Ω by the joint probability distribution

F(θ₁, . . . , θₛ_{^{N}})=Prob{θ(ωᵢ)≦θᵢ for i=1, . . . , S^{N}}, (17)

where θ(ωᵢ)ε Γ is the labor requirement at vertex i, each θᵢ is a positive scalar, and S^{N} is the total number of vertices (i.e., of production recipes). For a general introduction to random fields, see Griffeath (1976) or Vanmarcke (1983). The joint probability distribution in equation (17) induces a probability measure μ on (θ_{1, . . . ,} θ_{S}_{^{N}}). The mapping implicit in equation (2), along with the measure μ, form a probability space which is a random field on Γ, the technological graph. See Macken and Stadler (1995). Conditions for the existence of the joint probability measure, and hence the random field, are discussed in Durrett (1991, Chap. 2). In general then, a Technology Landscape L: Γ→ [symbol] ⁺ is a realization of [symbol] . The relationship between random fields and landscape models is discussed in Stadler and Happel (1995).

2.2 Correlation Structure of the Technology Landscape

Perhaps one of the most important properties of a technology landscape is its correlation structure. The correlation of a landscape measures the degree to which nearby locations on the landscape have similar labor efficiencies. A straightforward way to measure the correlation of a landscape is by means of the autocorrelation function:

$$ρ ( d ) = \frac{E ( {θ}_{i} {θ}_{j} \vert d ) - E ( {θ}_{i} ) E ( {θ}_{j} )}{σ ( {θ}_{i} ) σ ( {θ}_{j} )} \qquad ( 18 )$$

where ρ(d) is the landscape's correlation coefficient for efficiencies corresponding to production recipes θᵢ and θⱼ which are a distance d apart (Eigen et al. (1989)). The expectation E (θᵢθⱼ | d) is with respect to the probability distribution P(θᵢ,θⱼ|d) which will be defined later in section 5.

In the case of an Ne technology landscape the level of intranalities characterizing a production method induces the correlation structure on the landscape. To see this, consider first the limiting case of a production method characterized by e=1. In this case the contribution made by each operation to overall production cost is independent of the states of the other operations since the contribution to total cost made by each operation depends only on the state of that operation. Whether or not each operation in the production method makes its lowest possible contribution to total cost depends in turn on whether or not the operation in question occupies its optimal state. Therefore, there exists a single globally optimal configuration for the firm's production method under which each operation occupies its optimal state. Any other configuration, which must of necessity have a higher cost, can be sequentially changed to the globally optimal configuration by successively changing the state of each operation. Furthermore, any such suboptimal recipe lies on a connected pathway via more efficient one-operation variants to the single global optimum in the cost landscape. Given our additive specification for production cost, a transition to a one-operation variant neighbor of ωᵢ (i.e. changing the state of one operation) typically alters the cost of the production method by an amount O(1/N). When e=1, production methods a distance d=1 away in the cost landscape therefore have nearly the same production cost. Consequently, production methods in a e=1 cost landscape are thus very closely correlated in their production costs.

In contrast, in the e=N limit the contribution made by each operation to the cost of the production method depends on the state of all other operations. The cost contribution made by each operation is changed when even a single operation is altered. Consider any initial production method among the S^{N} possible recipes. Alteration of one of the production method's operations alters the combination of the e=N operations that bear on the cost of each operation. In turn, this alteration changes the cost of each operation to a randomly chosen value from the appropriate distribution. The total production cost of the new production recipe is therefore a sum of N new random variables, from which it follows that the new cost value is entirely uncorrelated with the old production cost. The cost of any given production method is therefore entirely uncorrelated with the cost of its nearest neighbors.

Following Weinberger (1990) and Fontana et al. (1993), we can formally derive a correlation coefficient for an Ne cost landscape. Suppose the firm moves from production method ω to production method ω, a distance d apart. Let p(d) be the probability for any given operation to be among the d operations that are changed by moving from ω to ω. The autocorrelation coefficient, p(d), for two production methods a distance d apart is then given by:

ρ(d)=1−p(d). (19)

The cost of an operation is unchanged if it is not one of the d operations that have been changed as the firm moved from ω to ω, and if it is not one of the e neighbors of any of the changed operations. These two events are statistically independent, and thus

$$p ( d ) = 1 - {[ 1 - \frac{d}{N} ] [ 1 - \frac{e}{N - 1} ]}^{d} , \qquad ( 20 )$$

from which it follows that

$$p ( d ) = {[ 1 - \frac{d}{N} ] [ 1 - \frac{e}{N - 1} ]}^{d} . \qquad ( 21 )$$

When d=1 and there are no production externalities

$$( e = 0 ) , ρ ( d ) = 1 - \frac{1}{N} ,$$

which for N>>1 is very close to 1; when every operation affects every other operation (e=N), ρ(d)=0.

When e increases, the landscape goes from being “smooth” and single peaked to being “rugged” and fully random. For low values of e the correlation spans the entire configuration space; the space is thus nonisotropic. As e increases, the configuration space breaks up into statistically equivalent regions, so the space as a whole becomes isotropic (Kauffman 1993).

A related measure of landscape correlation, and one which can be used to compare landscapes, is the correlation length. The correlation length, l, of a technology landscape is defined by

$${l}^{- 1} = {\sum }_{d \geq 0} ρ ( d ) . \qquad ( 22 )$$

For a correlation coefficient which decays exponentially with distance, the correlation length is the distance over which the correlation falls to 1/e of its initial value. For the Ne technology landscape

$$l = - \frac{1}{ln ρ} . \qquad ( 23 )$$

3 Search on the Technology Landscape

3.1 Search Cost

The firm walk's on a technology landscape is equivalent to a random search within a fixed population of possibilities (Stone (1975)). In the model presented here the firm seeks technological improvements by sampling d-variants of its currently utilized production recipe. It does this by selecting independent drawings from some distribution F, at a sampling cost of c per drawing (where c>0). The firm's search rule is fairly simple. Consider a firm that is currently utilizing production recipe ωᵢ, and whose labor efficiency is therefore θ(ωᵢ). The firm can take either of two actions: (1) keep using production recipe ωᵢ, or (2) bear an additional search cost c and sample a new production recipe ωⱼ ε N_{d} from the technology landscape. The decision rule followed by the firm is to change production recipes when an efficiency improvement is found, but otherwise keep the same recipe. Let θᵢ be the efficiency of the production recipe currently used by the firm, and let θⱼ be the efficiency of a newly sampled production recipe; if θⱼ>θᵢ, the firm adopts ωⱼ ∈ Ωin the next time period; if θⱼ≦θᵢ, the firm keeps using ωᵢ. This search rule is in effect an “uphill walk” on the landscape, with each step taken by the firm taking it to a d-operation variant of the firm's current production recipe.

The actual procedures used by the firm when searching for technological improvements can range from the non-intentional (e.g, “learning by doing”), to the strategic (investments in R & D); technological improvements can result from small scale innovations occurring in the shop-floor or from discoveries originating in a laboratory. The level of sophistication of the firm's search for new technologies is mapped into how many of the operations comprising the currently used production recipe have their states changed as the firm moves on its technology landscape. Production recipes sampled at large distances represent very different production processes while production processes separated by small distances represent similar processes. Improved variants found at large distances from the current recipe represent wholesale changes whereas nearby improved variants constitute refinements rather than large scale alterations.

The many issues of industrial organizational, quality control, managerial intervention and allocation of scarce research resources involved in firm-level technological change are here collapsed into the cost, c, which the firm must pay in order to sample from the space of possible configurations for its production recipe. We assume the unit cost of sampling to be a nondecreasing function of how far away from its current production recipe the firm searches for an improved configuration—recalling that in the metric used here the distance between two configuration in the technology landscape is the number of operations which must be changed in order to turn one production recipe into the other. For present purposes it suffices to have the relationship between search cost and search distance be a simple linear function of distance:

c=αd, (24)

where α ∈ [0, 1] and d(1≦d≦N) is the distance between the currently utilized production recipe, ωᵢ, and the newly sampled production recipe, ωⱼ.

3.2 Search Distance

At what distance away from its current production recipe should the firm search for technological improvements? In the most “naive” form of search on a technology landscape the firm restricts itself to myopically sampling among nearby variants in order to climb to a local optimum. Might it be better for the firm to search further away? The answer is “yes,” but the optimal search distance typically decreases as the labor efficiency of the firm's current production recipe increases since the room for improvement decreases.

Consider an Ne technology landscape with a moderately long correlation length and suppose that a firm starts production with a production recipe of average efficiency 0.5 (for the rest of the discussion the efficiency of production recipes will be normalized to lie between 0 and 1). Then half of the 1-operation variant neighbors of the initial production recipe are expected to have a lower labor efficiency, and half are expected to have higher efficiency. More generally, half the of the production recipe variants at any distance d=1, . . . , N away from the initial configuration should be more efficient and half should be less efficient. Since the technology landscape is correlated, however, nearby variants of the initial production recipe, those a distance 1 or 2 away, are constrained by the correlation structure of the landscape to be only slightly more or less labor efficient than the starting configuration. In contrast, variants sampled at a distance well beyond the correlation length, I, of the landscape can have efficiencies very much higher or lower than that of the initial production recipe.

It thus seems plausible to suppose that, early in the firm's search process from a poor or even average initial configuration, the more efficient variants will be found most readily by searching far away on the technology landscape. But as the labor efficiency increases, distant variants are likely to be nearly average in the space of possible efficiencies—hence less efficient—while nearby variants are likely to have efficiencies similar to that of the current, highly efficient, configuration. Thus, distant search will almost certainly fail to find more efficient variants, and search is better confined to the local region of the space.

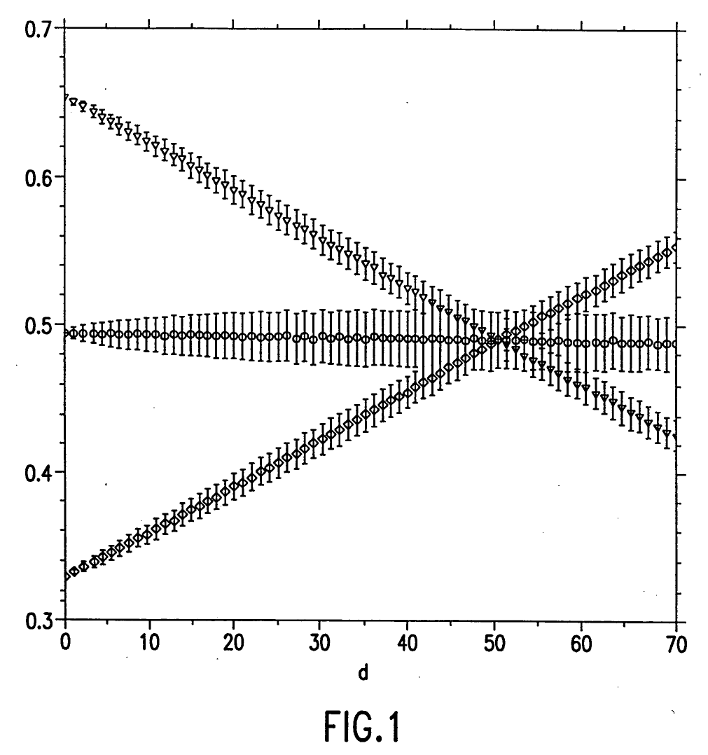

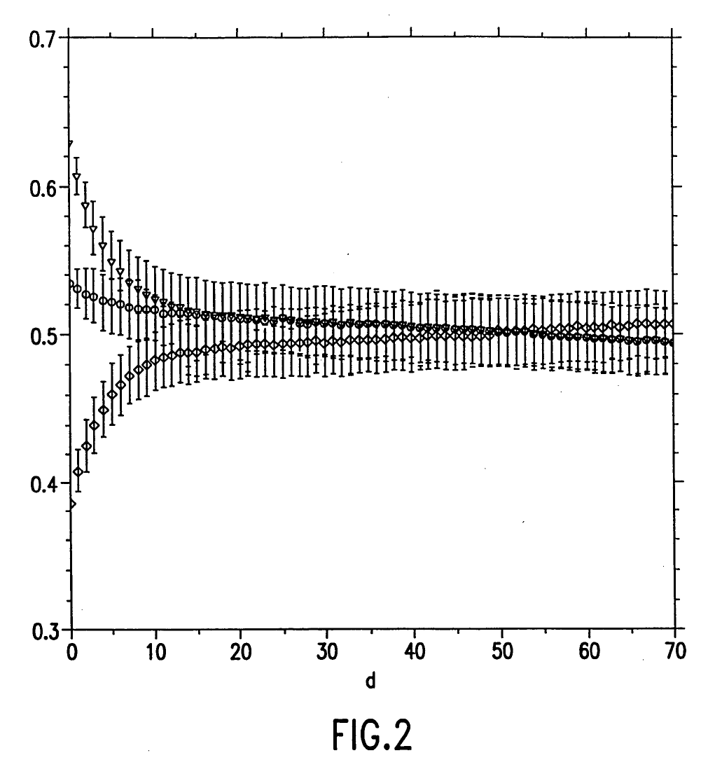

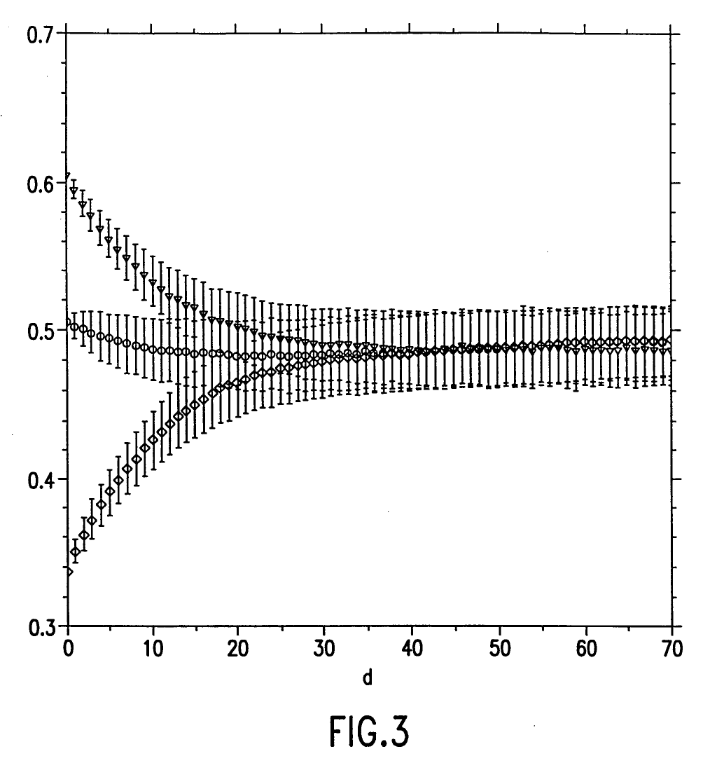

FIGS. 1 to 3 show the results of simulations exploring this intuition for a technology landscape with N=100, varying e values, S=2 and three different starting labor requirements (near 0.35, 0.50, and 0.70). The e intranalities are assigned at random from any of the other N−1 operations. The number of operations e^{j} affected by the j^{th} operation is binomially distributed. The labor cost φ^{j} of the jth operation is assigned randomly from the uniform distribution U(O, 1). The total labor requirement of a production recipe thus varies from 0 to 1, and for N large enough has a Gaussian distribution with mean ½. From each initial position, 5,000 variants were sampled at each search distance d=1, . . . , 100. Since N=100, a distance of, for example, d=70, corresponds to changing the state of 70 of the 100 operations in the binary string representing the firm's current position on the technology landscape. Each set of 5,000 samples at each distance yielded a roughly Gaussian distribution of labor requirements encountered at that search distance. FIGS. 1 to 3 show, at each distance, a bar terminating at one standard deviation above and one standard deviation below the mean labor requirement found at that distance. Roughly one-sixth of a Gaussian distribution lies above one standard deviation. Thus, if six samples had been taken at each distance, and the “best” of the six chosen, then the expected increase in labor efficiency at each distance is represented by the envelope following the “plus” one standard deviation marks at each distance. FIG. 1 shows that when e=1 and the initial labor efficiency is near 0.5, the optimal search distance with six samples occurs when around 50 of the 100 operations are altered. When the initial labor efficiency is high, however, the optimal search distance dwindles to the immediate vicinity of the starting configuration. In contrast, when the initial labor efficiency is much lower than the mean, it is optimal for the firm to jump (i.e. search far away) instead of “walk” (i.e. search nearby) across the technology landscape. For FIG. 2, where e=5, the correlation length is shorter and as a result the optimal search distance for initial efficiencies near 0.5 is smaller (in this case around d=5). It is still the case that for highly efficient initial recipes search should be confined to the immediate neighborhood. Very poor initial efficiencies still benefit most from distant search. In FIG. 3, where e=11, the correlation length of the technology landscape is shorter still and optimal search distances shrink further.

The numerical results suggest that on a technology landscape it is optimal to search far away when labor efficiency is low in order to sample beyond the correlation length of the configuration space. As labor efficiency increases, however, optimal search is confined closer to home. These results are intuitively appealing and common seismical. In the next two sections we provide an analytic framework with which to address optimal search distance. Section 4 outlines a formal framework with which to treat landscapes while Section 5 places search cost within a standard dynamic programming context.

4 Analytic Approximation for the Distribution of Efficiencies

Technology landscapes are very complex entities, characterized by a neighborhood graph Γ and an exponential number of labor efficiencies S^{N}. In any formal description of technology landscapes we have little hope of treating all of these details. Consequently we adopt a probabilistic approach focusing on the statistical regularities of the landscape.

To treat the technology landscape statistically we follow Macready (1996) and assume that the landscape can be represented using an annealed approximation. The annealed approximation (Derate and Pomeau (1986)) is often used to study systems with disorder (i.e. randomly assigned properties) as is the case with our Ne model. Recall that the labor efficiencies φ^{j} are assigned by random sampling from U (0, 1). In evaluating the statistical properties of the Ne landscape one must first sample an entire technology landscape and then measure some property on that landscape. Repeated sampling and measuring on many landscapes then yields the desired aggregate statistics. Analytically mimicking this process is difficult, however, because averaging over the landscapes is the final step in the calculation and usually results in an intractable integration. In our annealed approximation the averaging over landscapes is done before measuring the desired statistic, resulting in vastly simpler calculations. The annealed approximation will be sufficiently accurate for our purposes and we shall comment on the range of its validity.

As an example of our annealed approximation, lets assume we want to measure the average of a product of four efficiencies along a connected walk in Γ. Without loss of generality let's call these efficiencies θ₁,θ₂,θ₃,θ₄. If P(θ₁, . . . , θ_{S}_{^{N}}) is the probability distribution for an entire technology landscape this average is calculated as

∫θ₁θ₂θ₃θ₄P(θ₁, . . . , θ_{S}_{^{N}}dθ₁ . . . dθ_{S}_{^{N}}=∫P(θ₁,θ₂,θ₃,θ₄dθ₁dθ₂dθ₃dθ4. (25)

This integral may be difficult to evaluate depending on the form of P(θ₁,θ₂,θ₃,θ₄). Under the annealed approximation this integral is instead evaluated as

∫P(θ₁)θ₁P(θ₂|θ₁)θ₂P(θ₃|θ₂)θ₃P(θ₄|θ₃)θ₄dθ₁dθ₂dθ₃dθ₄, (26)

where P(θ|θ′) is the probability that a configuration has labor efficiency θ conditioned on the fact that a neighboring configuration has efficiency θ′.

As we have seen, under our annealed approximation the entire landscape is replaced by the joint probability distribution P(θ(ωᵢ), θ(ωⱼ)), where production recipes ωᵢ and ωⱼ are a distance one apart in Γ. For any particular technology landscape the probability that the efficiencies of a randomly chosen pair of configurations a distance d apart have efficiencies θ and θ′ is

$$P ( θ , {θ}^{′} \vert d ) = \frac{{\sum }_{ ( {ω}_{i} , {ω}_{j} ) d} δ ( θ - θ ( {ω}_{i} ) ) δ ( {θ}^{′} - θ ( {ω}_{j} ) )}{{\sum }_{( {ω}_{i} , {ω}_{j} ) d } 1} \qquad ( 27 )$$

where the notation (ωᵢ,ωⱼ)_{d} requires that production recipes ωᵢ and ωⱼ are a distance d apart and δ is the Dirac delta function. The Dirac delta function is the continuous analog of the Kronecker delta function: δ(x) is zero unless x=0 and is defined so that ƒ_{I} dx δ(x)=1 if the region of integration, I, includes zero. Rather than work with the full P(θ, θ′|d) we simplify and consider only

P(θ(ωᵢ),θ(ωⱼ))≡P(θ(ωᵢ),θ(ωⱼ)|d=1). (28)

For some technology landscape properties we might need the full P(θ(ωᵢ),θ(ωⱼ)|d) distribution but we will approximate it by building up from P(θ(ωᵢ),θ(ωⱼ)). More accurate extensions of this annealed approximation may be obtained if P(θ(ωᵢ),θ(ωⱼ)|d) is known.

From P(θ(ωᵢ),θ(ωⱼ)) we can calculate both P(θ(ωᵢ)),the probability of a randomly chosen production recipe ωᵢ, having efficiency θ(ωᵢ), and P(θ(ωᵢ)|θ(ωⱼ)), the probability of a production recipe ωᵢ having labor efficiency θ(ωᵢ) given that a neighboring production recipe ωⱼ labor efficiency θ(ωᵢ). Formally these probabilities are defined as

$$\begin{matrix}P ( θ ( {ω}_{i} ) ) = {\int }_{∞}^{- ∞} P ( θ ( {ω}_{i} ) , θ ( {ω}_{i} ) ) ⅆ θ ( {ω}_{j} ) , \\ and & ( 29 ) \\ P ( θ ( {ω}_{i} ) \vert θ ( {ω}_{j} ) ) = \frac{P ( θ ( {ω}_{i} ) , θ ( {ω}_{j} ) )}{P ( θ ( {ω}_{j} ) )} . & ( 30 )\end{matrix}$$

Note that we have assumed, for mathematical convenience, that labor efficiencies range over the entire real line. While efficiencies are no longer bounded from below, the ordering relationship amongst efficiencies is preserved and extreme labor efficiencies are very unlikely.

For Ne landscapes the following probability densities may be calculated exactly (Macready 1996):

$$\begin{matrix}P ( θ ( {ω}_{i} ) ) = \frac{1}{\sqrt{2 π}} exp [ - \frac{{θ}^{2} ( {ω}_{i} )}{2} ] , & ( 31 ) \\ P ( θ ( {ω}_{i} ) , θ ( {ω}_{j} ) ) = \frac{1}{2 π \sqrt{1 - {ρ}^{2}}} exp [ - \frac{{θ}^{2} ( {ω}_{i} ) + {θ}^{2} ( {ω}_{j} ) - 2 p θ ( {ω}_{i} ) θ ( {ω}_{j} )}{2 ( 1 - {ρ}^{2} )} ] , & ( 32 ) \\ P ( θ ( {ω}_{i} ) \vert θ ( {ω}_{j} ) ) = \frac{1}{2 π \sqrt{1 - {ρ}^{2}}} exp [ \frac{{θ ( {ω}_{i} ) - ρ θ ( {ω}_{i} ) )}^{2}}{2 ( 1 - {ρ}^{2} )} ] ; & ( 33 )\end{matrix}$$

where ρ=1−e/N and where have assumed without loss of generality that the mean μ(θᵢ) and variance σ²(θᵢ) of the technology landscape are 0 and 1, respectively. This annealed approach approximates the Ne technology landscape well when e/N˜1, that is, when p˜0, but can deviate in some respects when e/N˜0, i.e., when p˜1 (see Macready 1996)). Equations (31)-(33) define a more general family of landscapes characterized by arbitrary ρ.

Since we are interested in the effects of search at arbitrary distances d from a production recipe ωᵢ, we must infer P(θ(ωⱼ)|θ(ωᵢ),d) from P(θ(ωᵢ),θ(ωⱼ)). We shall not supply this calculation here but only sketch an outline of how to proceed (for full details see Macready (1996)). To begin, note that P(θ(ωⱼ)|θ(ωᵢ),d) is easily obtainable from P(θ(ωᵢ)|θ(ωⱼ),|d) as

$$P ( θ ( {ω}_{j} ) \vert θ ( {ω}_{i} ) , d ) = \frac{P ( θ ( {ω}_{i} ) , θ ( {ω}_{j} ) \vert d )}{P ( θ ( {ω}_{i} )} . \qquad ( 34 )$$

P(θ(ωᵢ),|θ(ωⱼ)|d) is not known but it is related to P(θ(ωᵢ),θ(ωⱼ)|s), the probability that an s-step random walk in the technology graph Γ beginning at ωᵢ and ending at ωⱼ has labor efficiencies θ(ωᵢ) and θ(ωⱼ) at the endpoints of the walk. Each step of the random walk either increases or decreases the distance from the starting point by 1. P(θ(ωᵢ),θ(ωⱼ)|s) is straightforward to calculate from equation (32). P(θ(ωᵢ),θ(ωⱼ)|d) is then obtained from P(θ(ωᵢ),θ(ωⱼ)|s) by including the probability that an s-step random walk on Γ results in a net displacement of d-steps. The result of this calculation is that P(θ(ωⱼ)|θ(ωᵢ),d) is Gaussianly distributed with a mean and variance given by:

μ(ωᵢ,d)=θ(ωᵢ)ρ^{d}, (35)

σ²(ωᵢ,d)=1−ρ^{2d}. (36)

Equations (35) and (36) play an important role in the next section.

5 Optimal Search Distance

5.1 The Firm's Search Problem

In order to determine the relationship between search cost and optimal search distance on a technology landscape, we recast the firm's search problem in the familiar framework of dynamic programming (Bellman (1957), Bertsekas (1976), Sargent (1987)). Recall that each production recipe ωᵢ ∈Ω(i=1 . . . S^{N}) is associated with a labor efficiency θᵢ₋ Production recipes at different locations in the technology landscape—and therefore at different distances from each other—have different Gaussian distributions corresponding to different μ(ωᵢ, d) and σ(ωᵢ, d). The firm incurs a search cost, c(d), every time it samples a production recipe a distance d away from the current production recipe. The search cost c(d) is a monotonically increasing function of d since more distant production recipes require greater changes to the current recipe. For simplicity we take c(d)=αd (see equation (24)) but arbitrary functional forms for c(d) are no more difficult to incorporate within our framework. The firm's problem is to determine the optimal search distance at which to sample the technology landscape for improved production recipes. Note that since E[θ²]<<∞, by assumption, an optimal stopping rule exists for the firm's search (DeGroot (1970), Ch. 13).

To determine the optimal distance at which to search for new production recipes we begin by denoting the firm's current labor efficiency by z and supposing that the firm is considering sampling at a distance d. If F_{d}(θ) is the cumulative probability distribution of efficiencies at distance d, the firm's expected labor efficiency, E(θ|d), searching at distance d is given by

E(θ|d)=−c(d)+β(z∫_{-∞}^{z}dF_{d}(θ)+∫_{z}^{∞}θdF_{d}(θ)). (37)

where β is the discount factor. It may be the case that this discount factor is d-dependent since larger changes in the production recipe would likely require more time but we shall assume for simplicity that β is independent of d. The difference in labor efficiencies between searching at distance d and remaining with the current production recipe, D_{d}(z), is given by:

$$\begin{matrix}{D}_{d} ( z ) = E ( θ \vert d ) - z , & ( 38 ) \\ = - c ( d ) + β ( z {\int }_{- ∞}^{z} ⅆ {F}_{d} ( θ ) + {\int }_{z}^{∞} θ ⅆ {F}_{d} ( θ ) ) - z & ( 39 ) \\ = - c ( d ) - ( 1 - β ) z + β {\int }_{z}^{∞} ( θ - z ) ⅆ {F}_{d} ( θ ) . & ( 40 )\end{matrix}$$

D_{d}(z) is a monotonically decreasing function of z which crosses zero at z_{c}(d), determined by D_{d}(z_{c}(d))=0. For z<z_{c}(d) it is best to sample a new production recipe ωⱼ since D_{d}(z) is positive. If z>z_{c}(d) it is best to remain with the current recipe ωᵢ because D_{d}(z) will be negative and the cost will outweigh the potential gain. The zero-crossing value z_{c}(d) thus plays the role of the firm's reservation price (Kohn and Shavell (1974), Bikhchandani and Sharma (1996)). The reservation price at distance d is determined from the integral equation:

c(d)+(1−β)z_{c}(d)=β∫_{z}_{_{c}}_{(d)}^{∞}(θ−z_{c}(d))dF_{d}(θ). (41)

From equation (41) it can be seen that, as expected, reservation price decreases with greater search cost.

The firm's optimal search strategy on its technology landscape can be characterized by Pandora's Rule: if a production recipe at some distance is to be sampled, it should be a production recipe at the distance with the highest reservation price. The firm should terminate search and remain with the current production recipe whenever the current labor efficiency is greater than the reservation price of all distances (a proof of this result is found in Weitzman (1979)).

5.2 The Reservation Price for Gaussian Efficiencies

In the case where labor efficiencies at distance d are Gaussianly distributed, equation (41) reads as (For clarity the d dependence of z_{c} has been omitted)

$$\begin{matrix}c ( d ) + ( 1 - β ) {z}_{c} = \frac{β}{\sqrt{2 Π}} {\int }_{{z}_{c}}^{∞} \frac{d θ}{σ ( {ω}_{i} , d )} ( θ - {z}_{c} ) exp [ - \frac{{( θ - μ ( {ω}_{i} , d ) )}^{2}}{2 {σ}^{2} ( {ω}_{i} , d )} ] , & ( 42 ) \\ = \frac{β}{\sqrt{2 Π}} {\int }_{0}^{∞} \frac{d u}{σ ( {ω}_{i} , d )} u exp ⌊ - \frac{{( u + {z}_{c} - μ ( {ω}_{i} , d ) )}^{2}}{2 {σ}^{2} ( {ω}_{i} , d )} ⌋ . & ( 43 )\end{matrix}$$

From the indefinite integral

$$\begin{matrix}\frac{d u}{b} u exp ⌊ - \frac{{( u - a )}^{2}}{2 {b}^{2}} ⌋ = - b exp ⌊ - \frac{ {( u - a )}^{2}}{2 {b}^{2}} ⌋ + a \sqrt{\frac{Π}{2}} e r f [ - \frac{u - a}{\sqrt{2} b} ] \\ we find & ( 44 ) \\ {\int }_{0}^{∞} \frac{d u}{b} u exp ⌊ - \frac{{( u - a )}^{2}}{2 {b}^{2}} ⌋ = b exp ⌊ - \frac{{a}^{2}}{2 {b}^{2}} ⌋ + a \sqrt{\frac{Π}{2}} erfc [ - \frac{a}{\sqrt{2} b} ] & ( 45 )\end{matrix}$$

where er ƒ[·] is the error function and er ƒc[·]=1−erƒ[·] is the complimentary error function. The error function er ƒ(x) is defined as

$$\frac{2}{\sqrt{Π}} {\int }_{0}^{x} {ⅇ}^{- {t}^{2}} ⅆ t$$

and the complimentary error function, er ƒc(x) is defined as

$$\frac{2}{\sqrt{Π}} {f}_{x}^{∞} {ⅇ}^{- {t}^{2}} ⅆ t .$$

From these definitions it is easy to show that er ƒ(x)+er ƒc(x)=1, er ƒ(∞)=1 and er ƒc(−∞)≡2−er ηc(x). With this result the equation determining the reservation price now reads:

$$c ( d ) + ( 1 - β ) {z}_{c} = β ( \frac{μ ( {ω}_{i} , d ) - {z}_{c}}{2} e r f c [ - \frac{μ ( {ω}_{i} , d ) - {z}_{c}}{\sqrt{2 σ} ( {ω}_{i} , d )} ] + \\ \frac{σ ( {ω}_{i} , d )}{\sqrt{2 Π}} exp [ - \frac{{( μ ( {ω}_{i} , d ) - {z}_{c} )}^{2}}{2 {σ}^{2} ( {ω}_{i} , d )} ] ) . \qquad ( 46 )$$

To simplify the appearance of this equation we write it using the dimensionless variable

$$δ = \frac{{z}_{c} - μ ( {ω}_{i} , d )}{\sqrt{2} σ ( {ω}_{i} , d )} , \qquad ( 47 )$$

in terms of which z_{c}=\sqrt{2}σ(ωᵢ, d)δ+μ(ωᵢ, d). The dimensionless reservation price δ is then determined by

$$\begin{matrix}\frac{\sqrt{2} ( c ( d ) + ( 1 - β ) μ ( {ω}_{i} , d ) )}{σ ( {ω}_{i} , d )} = β ( \frac{exp [ - {δ}^{2} ]}{\sqrt{Π}} - δ erfc [ δ ] ) - 2 ( 1 - β ) δ , & ( 48 ) \\ = β ( \frac{exp [ - {δ}^{2} ]}{\sqrt{Π}} + δ erfc [ - δ ] ) - 2 δ . \\ Defining & ( 49 ) \\ A ( {ω}_{i} , d ) ≡ \frac{\sqrt{2} ( c ( d ) + ( 1 - β ) μ ( {ω}_{i} , d )}{σ ( {ω}_{i} , d )} , & ( 50 )\end{matrix}$$

the equation which must be solved for δ is therefore:

$$A ( {ω}_{i} , d ) ≡ β ( \frac{exp [ - {δ}^{2} ]}{\sqrt{Π}} + δ erfc [ - δ ] ) - 2 δ . \qquad ( 51 )$$

The explicit ωᵢ and d dependence of A is obtained by plugging equations (35) and (36) into equation (50). Equation (51) is the central equation determining the reservation price z_{c}(d). Approximate solutions to this equation are considered in the next section, 6.3.

The optimal search distance, d*, is now determined as

d*≡arg max_{d}z_{c}(d). (52)

where the d-dependence of z_{c}(d) is implicitly determined by Equation (51). As a function of d, z_{c} is well behaved with a single maximum so that d* is the integer nearest to the d which solves ∂_{d}z_{c}=0. We now proceed to find the equation which d* satisfies.

To begin, recall the definition of δ given in Equation (47). Taking the d derivative of δ yields

∂_{d} z_{c}=\sqrt{2}((δ∂_{d}σ(ωᵢ, d)+σ(ωᵢ, d)∂_{d}δ)+∂_{d}μ(ωᵢ, d). (53)

The partial derivatives ∂_{d}μ and ∂_{d}σ are given by

∂_{d}μ(ωᵢ, d)=dθ(ωᵢ)ρ^{d-1}, (54)

∂_{d}σ(ωᵢ, d)=−2dρ^{2d-1}, (55)

respectively, and we wish to express ∂_{d}δ in terms of these known quantities. Differentiating equation (51) with respect to d yields.

$${\partial }_{d} σ = \frac{{\partial }_{d} A ( {ω}_{i} , d )}{β erfc [ - δ ] - {2}^{′}} \qquad ( 56 )$$

(assuming β is not d-dependent). Thus d* is determined by

$$0 = \sqrt{2} ( δ {\partial }_{d} σ + \frac{σ {\partial }_{d} A}{β erfc [ - δ ] - 2} ) + {\partial }_{d} μ . \qquad ( 57 )$$

Using the definition of A in equation (50) its derivative is easily found as

$${\partial }_{d} A = \frac{\sqrt{2}}{σ} {\partial }_{d} c + \frac{\sqrt{2} ( 1 - β )}{σ} {\partial }_{d} μ - \frac{A}{σ} {\partial }_{d} σ . \qquad ( 58 )$$

Plugging this result in we find

$$0 = \sqrt{2} ( δ {\partial }_{d} σ + \frac{\sqrt{2} {\partial }_{d} c + \sqrt{2} ( 1 - β ) {\partial }_{d} μ - A {\partial }_{d} σ}{β erfc [ - σ ] - 2} ) + {\partial }_{d} μ , \qquad ( 59 )$$

which can be rearranged to give

0=2∂ₐc+\sqrt{2} (βδer ƒc[−δ]−2δ−A)∂_{d}σ+β(er ƒc[−σ]−2)∂_{d}μ. (60)

Finally, we use equation (51) to simplify this to,

$$\frac{2}{β} {\partial }_{d} c = \sqrt{\frac{2}{Π}} exp [ - {δ}^{2} ] {\partial }_{d} σ + erfc [ δ ] {\partial }_{d} u \qquad ( 61 )$$

where ∂_{d}μ and ∂_{d}σ are given in equation (55).

5.3 Determination of the Reservation Price

It is desirable to have an explicit solution for δ (implicitly determined by equation (51)). To this end we note some features of the function

$${D}_{A} ( δ ) ≡ β ( \frac{exp [ - {δ}^{2} ]}{\sqrt{Π}} + δ erfc [ - δ ] ) - 2 δ - A ( {ω}_{i} , d ) . \qquad ( 62 )$$

Firstly, note that

$$\begin{matrix}{lim}_{δ \to - ∞} {D}_{A} ( δ ) = ∞ , & ( 63 ) \\ {lim}_{δ \to ∞} {D}_{A} ( δ ) = - A , & ( 64 )\end{matrix}$$

and that D_{A}(δ) is monotonic. Thus, there is no solution to D_{A}(δ)=0 unless A>0. If A<0 then it is always profitable to try new production recipes. This is the case for example when c(d) is negative and is sufficiently large in magnitude. We assume that the firm is not paid to try new production recipes and confine ourselves to the case A>0.

In the case A>>1, the solution δ of D_{A}(δ)=0 is large and negative. In this case the term multiplying β is almost zero and to a very good approximation the solution of D_{A}(δ)=0 is

$$δ = - \frac{A}{2} \qquad ( 65 )$$

or z_{c}(d)=−c(d)+β(ωᵢ, d). The d dependence of the reservation price in this limit is particularly simple:

z_{c}(d)=βθρ^{d}−ad. (66)

This is maximal for d=0 corresponding to terminating the search. This result makes intuitive sense because if A is large then either costs are high and additional sampling is too expensive or labour efficiencies are high and it is unlikely to find improved production recipes. We thus find that there are diminishing returns to search depending upon the firm's current location in the technological landscape.

In the opposite limit, 0<A<<1, the solution is at δ large and positive. In this case we use the asymptotic expansion (The Γ function is defined by Γ(x)=∫₀^{∞}dt exp [−t]t^{x-1}. For integer x, Γ(x)=(x−1)!.)

$$erfc [ - δ ] 2 - \frac{exp [ - {δ}^{2} ]}{π} {\sum }_{k = 0}^{n - 1} \frac{{( - 1 )}^{k} Γ ( k + 1 / 2 )}{{δ}^{2 k + 1}} + \frac{exp [ - {δ}^{2} ]}{π} {R}_{n} , \qquad ( 67 )$$

where |Rₙ|<Γ(n+½)/δ²ⁿ⁺¹. Working to third order in 1/δ and recalling that

Γ(½)=\sqrt{π}

gives the approximate equation:

$$A ( {ω}_{i} , d ) = 2 ( β - 1 ) δ + \frac{β}{2 \sqrt{π} {δ}^{2}} exp [ - {δ}^{2} ] . \qquad ( 68 )$$

In the special case β=1, δ is determined by

$${δ}^{2} exp [ {δ}^{2} ] \frac{1}{2 \sqrt{π} A} \qquad ( 69 )$$

which has the solution

$$δ = \sqrt{W [ \frac{1}{2 \sqrt{π} A} ]} \qquad ( 70 )$$

where W[·] is Lambert's W function (See Corless et al (1996) for a good introduction to Lambert's W function) defined implicitly by W[x] exp W[x]=x. For small A we can use the asymptotic expansion W(x)˜ln x (see Corless et. al (1996)) to write

$$δ ∼ \sqrt{- ln [ 2 \sqrt{π} A ]} = \sqrt{- ln [ 2 \sqrt{2 π} σ ( ω , d ) / c ( d ) ]} . \qquad ( 71 )$$

5.4 Numerical Results

In this section we present results for the optimal search distance as a function of (i) the initial labor efficiency of the firm, (ii) the cost of search as represented by α in c(d)=αd and (iii) the correlation p of the technology landscape. For brevity we will not present the β dependence but note that β<1 decreases the optimal search distance.

In appropriate parameter regimes we have used the approximations in equations (65) and (68), elsewhere we have resorted to a numerical solution to equations (51) and (61).

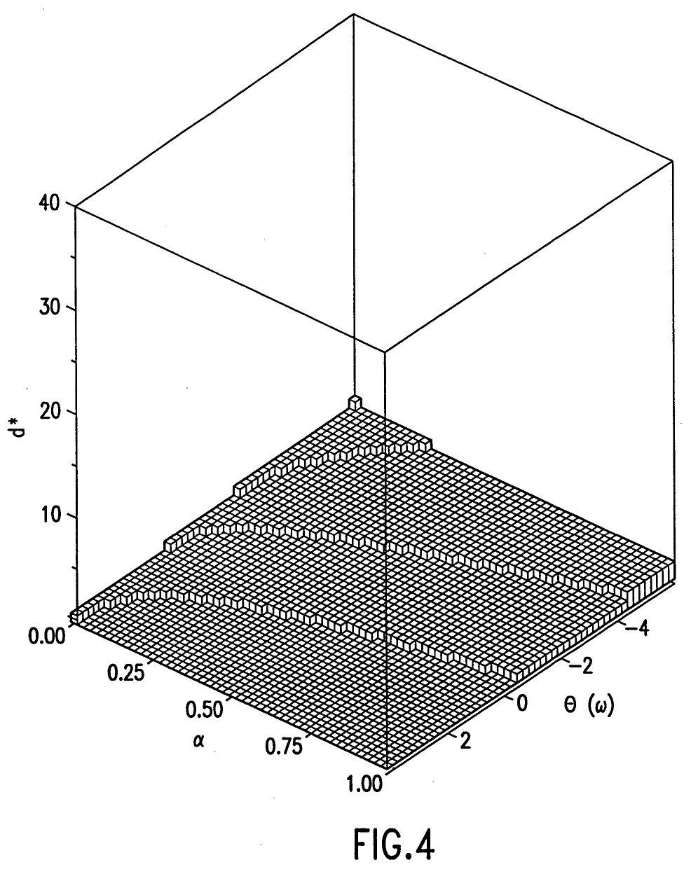

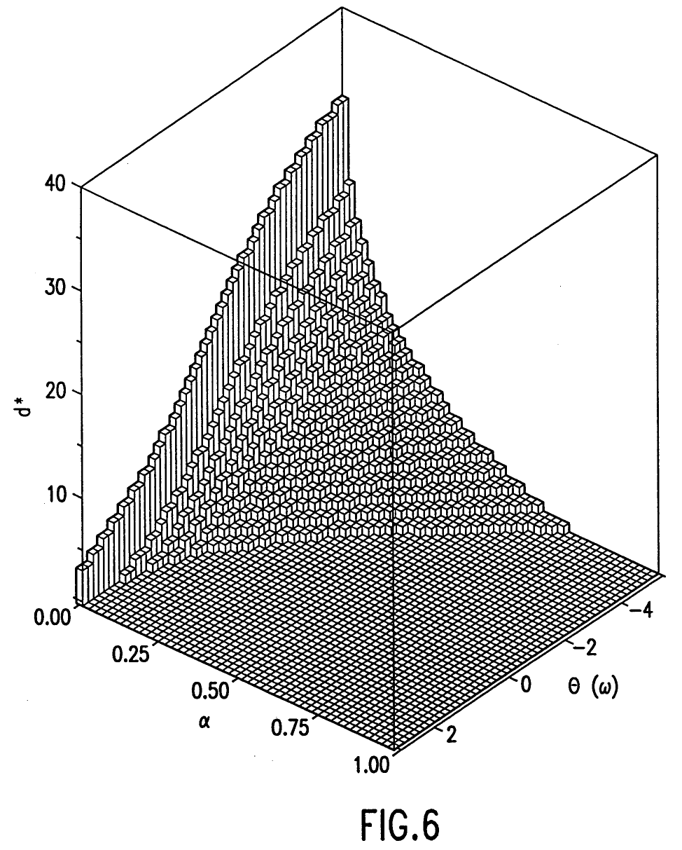

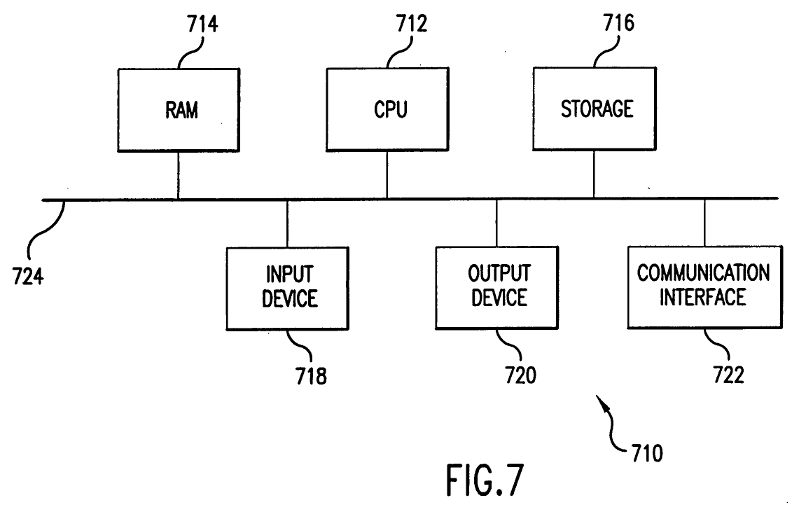

FIGS. 4 to 6 present the optimal search distance d* as a function of the firm's current efficiency and the search cost parameter, α. In regions of parameter space in which the optimal search distance is zero it is best to terminate the search and not search for more efficient production recipes. We note a number of features paralleling the simulation results presented in Section 4.2. In general, for low initial efficiencies it is better for the firm to search for improved production recipes farther away. As search costs increase (i.e., as α increases), the additional cost limits optimal search closer to the firm's current production recipe. For production recipes which are initially efficient, the advantages of search are much less pronounced and for high enough initial efficiencies it is best to consider only single-operation variants. Again, a higher cost of search results in even smaller optimal search distances.

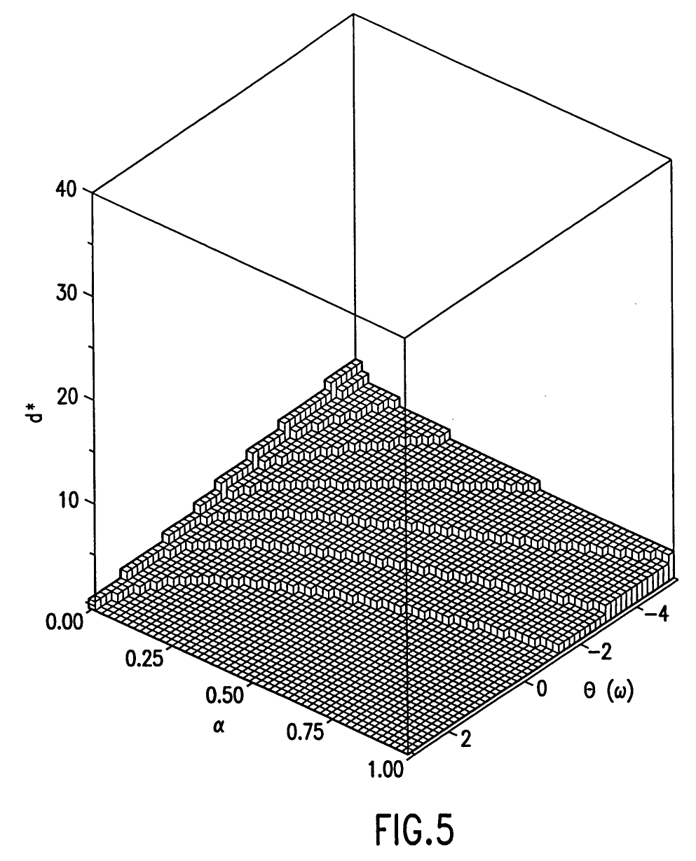

The effects of landscape correlation (as measured by ρ) on optimal search distance are dramatic. On highly correlated technology landscapes (e.g., ρ=0.9), correlation extends across large distances and as a result large optimal search distances are obtained (see FIG. 4). For less correlated landscapes (e.g., ρ=0.6), optimal search distances shrink (FIG. 5). For a technology landscape with an even smaller correlation structure (ρ=0.3), optimal search distances shrink even more. In the limiting case of a completely uncorrelated technology landscape (ρ=0), all search distances are equivalent since no landscape correlation exists to exploit during the search.

6 Conclusion

In this discussion we have been concerned with the determination of the optimal distance at which a firm should seek technological improvements in a space of possible technologies. In our model the firm's technology is determined by its organizational capital which in turn is represented by a production recipe whose N constituent operations can occupy S discrete states. Different configurations for a production recipe represent different technologies. Production recipes are also characterized by the level of external economies and diseconomies among the recipe's operations; the parameter e measures the level of “intranalities” of a production recipe. The distance between any two distinct production recipes in the space of technological possibilities is naturally determined by the number of operations whose states need to be changed in order to turn one configuration into another.

In order to study how the current location of the firm in the space of technological possibilities affects the firm's search for technological improvements, we model the firm's search as movement on a “technology landscape.” The locations in the landscape correspond to different configurations for the firm's production recipe. Local maxima and minima for the labor efficiency associated with each production recipe are represented by “peaks” and “valleys” in the landscape. The “ruggedness” of the landscape is in turn determined by the landscape's correlation coefficient, ρ.

Our initial investigation about the firm's optimal search distance involved computational exploration of the Ne technology landscape. The obtained simulation results prompted the development of a formal framework in which a technology landscape was incorporated into a standard dynamic programming model of search. The resulting framework abstracts away from all landscape detail except the important statistical structure which is captured in relatively simple probability distributions. As our main result we find that early in the search for technological improvements, if the initial position is poor or average, it is optimal to search far away on the technology landscape. As the firm succeeds in finding technological improvements, however, it is optimal to confine search to a local region of the technology landscape. Our modeling framework results in an intuitive and satisfying picture of optimal search as a function of the cost of search (which is itself a function of the distance between the firm's currently utilized production recipe and the newly sampled recipe), the firm's current location on the space of technological possibilities and the correlation structure of the technology landscape.

The general features of the story told in this application—that early search can give rise to dramatic improvements via significant alterations found far away across the space of possibilities but that later search closer to home yields finer and finer twiddling with the details—suggests a possible application of our model to treat the development of “design types.” Among the stylized facts accepted by most engineers is the view that, soon after a major design innovation, improvement occurs by the emergence of dramatic alterations in the fundamental design. Later, as improvements continue to accumulate, variations settle down to minor fiddling with design details. We need only to think of the variety of forms of the early bicycles—big-front-wheel-small-back-wheel, small-front-wheel-big-back-wheel, various handle-bars—or of the forms of aircraft populating the skies in the early decades of the century. Dyson (1997) estimates that there were literally thousands of aircraft designs flown during the 1920s and 1930s of which only a few hundred survived to form the basis of modern aviation.

FIG. 7 discloses a representative computer system 710 in conjunction with which the embodiments of the present invention may be implemented. Computer system 710 may be a personal computer, workstation, or a larger system such as a minicomputer. However, one skilled in the art of computer systems will understand that the present invention is not limited to a particular class or model of computer.

As shown in FIG. 7,representative computer system 710 includes a central processing unit (CPU) 712, a memory unit 714, one or more storage devices 716, an input device 718, an output device 720, and communication interface 722. A system bus 724 is provided for communications between these elements. Computer system 710 may additionally function through use of an operating system such as Windows, DOS, or UNIX. However, one skilled in the art of computer systems will understand that the present invention is not limited to a particular configuration or operating system.

Storage devices 716 may illustratively include one or more floppy or hard disk drives, CD-ROMs, DVDs, or tapes. Input device 718 comprises a keyboard, mouse, microphone, or other similar device. Output device 720 is a computer monitor or any other known computer output device. Communication interface 722 may be a modem, a network interface, or other connection to external electronic devices, such as a serial or parallel port

While the above invention has been described with reference to certain preferred embodiments, the scope of the present invention is not limited to these embodiments. One skill in the art may find variations of these preferred embodiments which, nevertheless, fall within the spirit of the present invention, whose scope is defined by the claims set forth below.

### REFERENCES

[1] Adams, J. D. and L. Sveikauskas (1993) “Academic Science, Industrial R & D, and the Growth of Inputs.” Center for Economic Studies Discussion Paper 93-1. Washington, D.C.: U.S. Bureau of the Census.

[2] Audretach, D. (1991) “New Firm Survival and the Technological Regime,” Review of Economics and Statistics, 73, 441-450.

[3] Audretsch, D. (1994) “Business Survival and the Decision to Exit,” Journal of Business Economics, 1, 125-138.

[4] Auerswald, P., S. Kauffman, J. Lobo and K. Shell (1998) “A Microeconomic Theory of Learning-by-Doing: An Application of the Nascent Technology Approach,” forthcoming in Journal of Economic Dynamics and Control.

[5] Auerswald, P. and 1. Lobo (1995) “Learning by Doing, Technological Regimes and Industry Evolution,” presented at 71st Annual Meeting of the Western Economic Association, San Francisco, Calif.

[6] Bailey, M. N., E. J. Bartelsman and J Haltiwanger (1994) “Downsizing and Productivity Growth: Myth or Reality?” Center for Economic Studies Discussion paper 94-4. Washington, D.C.; U.S. Bureau of the Census.

[7] Barney, J. B. (1991) “Firm Resources and Sustained Competitive Advantage,” Journal of Management, 17, 99-120.

[8] Bellman, R. (1957) Dynamic Programming. Princeton: Princeton University Press.

[9] Bertsekas, D. P. (1976) Dynamic Programming and Stochastic Control. New York: Aca-demic Press.

[10] Bikhchandani, S. and S. Sharma (1996) “Optimal Search with Learning,” Journal of Economic Dynamics and Control, 20, 333-359.

[11] Boeker, W. (1989) “Strategic Change: The Effects of Founding and History, Academy of Management Journal, 32, 489-515.

[12] Cameron, P. J. (1994) Combinatorics: Topics, Techniques and Algorithms. New York: Cambridge University Press.

[13] Coase, R. (1937) “The Nature of the Firm,” Economica, 4, 386-405.

[14] Cohen, W. M. and D. A. Levinthal (1989) “Innovation and Learning: The Two Faces of R&D,” Economic Journal, 99, 569-596.

[15] Corless R. M., G. H. Gannet, D. E. G. Hare, D. J. Jeffrey, and D. E. Knuth (1996) “On the Lambert W Function,” Advances in Computational Mathematics, 5, 329-359.

[16] Davis, S. J. and J. Haltiwanger (1992) “Gross Job Creation, Gross Job Destruction, and Employment Reallocation,” Quarterly Journal of Economics, 107, 819-863.

[17] DeGroot, M. H. (1970) Optimal Statistical Decisions. New York: McGraw-Hill Book Company.

[18] Derate, B. and Y. Pomeau (1986) “Random Networks of Automata: A Simple Annealed Approximation,” Europhysics Letters, 1, 45-49.

[19] Dunne, T., M. Roberts and L. Samuelson (1988) “Patterns of Firm Entry and Exit in U.S. Manufacturing Industries,” RAND Journal of Economics, 19, 495-515.

[20] Dunne, T., M. Roberts and L. Samuelson (1989) “The Growth and Failure of U.S. Manufacturing Plants,” Quarterly Journal of Economics, 104, 671-698.

[21] Dunne, T., J. Haltiwanger and K. B.. Troske (1996) “Technology and Jobs: Secular Change and Cyclical Dynamics.” NBER Working Paper 5656. Cambridge, Mass.: National Bureau of Economic Research.

[22] Durrett, R. (1991) Probability: Theory and Examples. Belmont, Calif.: Duxbury Press.

[23] Dwyer, D. W. (1995) ‘Technology Lacks, Creative Destruction and Non-Convergence in Productivity Levels.” Center for Economic Studies Discussion Paper 95-6. Washington D.C.: U.S. Bureau of the Census.

[24] Dyson, F. (1997) Imagined Worlds: The Jerusalem-Harvard Lectures. Cambridge, Mass.: Harvard University Press.

[25] Eigen, M, J. McCaskil and P. Schuster (1989) “The Molecular Quasispecies,” Advances in Chemical Physics, 75, 149-263.

[26] Ericson, R and A. Pakes (1995) “Markov-Perfect Industry Dynamics: A Framework for Empirical Work,” Review of Economic Studies, 62, 53-82.

[27] Evenson, R. E. and Y. Kislev (1976) “A Stochastic Model of Applied Research,” Journal of Political Economy, 84, 265-281.

[28] Fontana, W., P. F. Stadler, E. G. Bomberg-Bauer, T. Griesmacher, I. L. Hofacker, M. Tacker, P. Tarazona, E. D. Weinberger and P. Schuster (1993) “RNA Folding and Combinatory Landscapes,” Physicol Review E, 47, 2083-2099.

[29] Griffeath, D. (1976) “Introduction to Random Fields,” in Kemeny, J., J. Snell and A. Knapp, Denumerable Markov Chains. New York: Springer-Verlag.

[30] Hall, R E. (1993) “Labor Demand, Labor Supply, and Employment Volatility.” NBER Macroeconomics Annual, no. 6, 17-47.

[31] Helfat, C. E. (1994) “Firm Specificity and Corporate Applied R&D,” Organization Science, 5, 173-184.

[32] Henderson, R. M. and K. B. Clark (1990) “Architectural Innovation: The Reconfiguration of Existing Product Technology and the Failure of Established Firms,” Administrative Science Quarterly, 35, 9-31.

[33] Herriott, S. R, D. A. Levinthal and J. G. March (1985) “Learning from Experience in Organizations,” American Economic Review, 75, 298-302.

[34] Hey, J. D. (1982) “Search for Rules of Search,” Journal of Economic Behavior and Organization, 3, 65-81.

[35] Hopenhayn, H. (1992) “Exit, Entry, and Firm Dynamics in Long Run Equilibrium,” Econometrica, 60, 1127-1150.

[36] Jones, T. (1994) “A Model of Fitness Landscapes.” Santa Fe Institute Working Paper 94-02-01. Santa Fe: The Santa Fe Institute.

[37] Jovanovic, B. (1982) “Selection and the Evolution of an Industry,” Econometrica, 50, 659-670.

[38] Jovanovic, B. and R. Rob (1990) “Long Waves and Short Waves: Growth Through Intensive and Extensive Search,” Econometrica, 58, 1391-1409.

[39] Kauffman, S. and S. Levin (1987) ‘Towards a General Theory of Adaptive Walks on Rugged Landscapes,” Journal of Theoretical Biology, 128, 11-45.

[40] Kauffman, S. (1993) Origins of Order: Self-Organization and Selection in Evolution. New York: Oxford University Press.

[41] Kennedy, P. M. (1994) “Information Processing and Organizational Design,” Journal of Economic Behavior and Organization, 25 37-51.

[42] Kindermann, R. and J. L. Snell (1980) Markov Random Fields and Their Applications. Providence: American Mathematical Society.

[43] Kahn, M. and S. Shavell (1974) “The Theory of Search,” Journal of Economic Theory, 9,. 93-123.

[44] Lee, D. M. and T. J. Allen (1982) “Integrating New Technical Staff: Implications for Acquiring New Technology,” Management Science, 28, 1405-1420.

[45] Levinthal, D. A. and 3.0. March (1981) “A Model of Adaptive Organizational Search,” Journal of Economic Behavior and Organization, 2, 307-333.

[46] Macken, C. A. and P. F. Stadler (1995) “Evolution on Fitness Landscapes,” in Nadel, L. and D. Stein, editors, 1993 Lectures in Complex Systems. Reading, Mass.: Addison-Wesley Publishing Company.

[47] Macready, W. G. (1996) “An Annealed Theory of Landscapes, Part I,” Sante Fe Institute Technical Report 96-03-030. Santa Fe: The Santa Fe Institute.

[48] March, J. G. (1991) “Exploration and Exploitation in Organizational Learning, ” Organization Science, 2, 71-87.

[49] Marengo, L. (1992) “Coordination and Organizational Learning in the Firm,” Journal of Evolutionary Economics, 2, 313-326.

[50] Muth, J. F. (1986) “Search Theory and the Manufacturing Progress Functions” Management Science, 32, 948-962.

[51] Nelson, R. R. and S. G. Winter (1982) An Evolutionary Theory of Economic Change. Cambridge, Mass.: Belknap Press.

[52] Papadimitriou, C. H. and K. Steiglitz (1982) Combinatorial Optimization: Algorithms and Complexity. Englewoods Cliffs, N.J.: Prentice-Hall.

[53] Presscott, E. and M. Visscher (1980) “Organization Capital,” Journal of Political Economy, 88, 446-461.

[54] Reiter, S. and G. R. Sherman (1962) “Allocating Indivisible Resources Affording External.Economies of Diseconomies,” International Economic Review, 3, 108-135.

[55] Reiter, S. and G. R. Sherman (1965) “Discrete Optimizing,” SIAM Journal, 13, 864-889.

[56] Romer, P. M. (1990) “Eudogenous Technological Change,,” Journal of Political Economy, 98, 71-102.

[57] Sahal, D. (1985) “Technological Guideposts and Innovation Avenues,” Research Policy, 14, 61-82.

[58] Sargent, T. J. (1987) Dynamic Macroeconomic Theory. Cambridge, Mass.: Harvard University Press.

[59] Shan, W. (1990) “An Empirical Analysis of Organizatonal Strategies by Entrepreneurial High-Technology Firms,” Strategic Management Journal, 11, 129-139.

[60] Stadler,, P. F. (1995) “Towards a Theory of Landscapes.” Social Systems Research Institute Working Paper Number 9506. Madison: University of Wisconsin.

[61] Stadler, P. F. and B.. Happel (1995) “Random Field Models for Fitness Landscapes.” Santa Fe Institute Working Paper 95-07-069. Santa Fe: The Santa Fe Institute.

[62] Stone, L. D. (1975) Theory of Optimal Search. New York: Academic Press.

[63] Sutton, J. (1997) “Gilbrat's Legacy,” Journal of Economic Literature, 35, 40-59.

[64] Tesler, L. G. (1982) “A Theory of Innovation and its Effects,” The Bell Journal of Economics, 13, 69-92.

[65] Tovey, C. (1985) “Hill Climbing with Multiple Local Optima,” SIAM Journal of Algebra and Discrete Methods, 6, 384-393.

[66] Tushman, M. L. and P. Anderson (1986) “Technological Discontinuities and Organizational Environments,” Administrative Science Quarterly, 14, 311-347.

[67] Vanmarcke, B. (1983) Random Fields: Analysis and Synthesis. Cambridge, Mass.: The MIT Press.

[68] Weinberger, E. D. (1990) “Correlated and Uncorrelated Fitness Landscapes and How to Tell the Difference,” Biological Cybernetics, 63, 325-336.

[69] Weitzman, M. L. (1979) “Optimal Search for the Best Alternative,” Econometrica, 47, 641-654.

[70] Williamson, 0. (1985) The Economic Institution of Capitalism: Firms, Markets and Relational Contracting. New York: The Free Press.

1. A method for improving a current production recipe, ωᵢ, comprising the steps of:
defining a space of a plurality of production recipes, Ω;
defining a distance, d, between two of said plurality of production recipes ωᵢ, ωⱼ ∈Ω;
defining an efficiency for at least one of said plurality of production recipes;
determining an optimal sampling distance, d*, from the current production recipe ω_{i,}; and
searching at said optimal sampling distance d* from the current production recipe ωᵢ, for at least one new production recipe ω_{j,} wherein the efficiency of said new production recipe ω_{j,} is greater than the efficiency of the current production recipe ω_{i,}.

2. A method for improving a current production recipe, ω_{i,}, as in claim 1 wherein each of said plurality of production recipes comprises N operations wherein N is a natural number.

3. A method for improving a current production recipe, ω_{i,}, as in claim 2 wherein said distance d between said two of said plurality of production recipes ω_{i,} ωⱼ ∈Ω is defined as the minimum number of said N operations that must be changed to convert said production recipe ω_{i,} to said production recipe ω_{j,}.

4. A method for improving a current production recipe, ω_{i,}, as in claim 1 wherein said defining an optimal sampling distance step comprises the steps of:
defining an efficiencies difference function as:
D_{d}(z)=E(θ|d)−z,
wherein:
E(θ|d)
is the expected value of said efficiency at distance d from the current production recipe ω_{i,}; and
z
is the efficiency of the current production recipe ωᵢ;
defining a reservation price at distance d as the zero crossing value, z_{c}(d) of said efficiencies difference function; and
defining said optimal sampling distance d* as the distance from the current production recipe having the highest value of said reservation price.

5. A method for improving a current production recipe, ω_{i,}, as in claim 4 wherein said efficiency for at least one of said plurality of production recipes has a Gaussian distribution.

6. Computer executable software code stored on a computer readable medium, the code for improving a current production recipe, ω_{i,}, the code comprising:
code to define a space of a plurality of production recipes, Ω;
code to define a distance, d, between two of said plurality of production recipes ω_{i,}ωⱼ ∈Ω;
code to define an efficiency for at least one of said plurality of production recipes;
code to determine an optimal sampling distance, d*, from the current production recipe ω_{i,}; and
code to search at said optimal sampling distance d* from the current production recipe ω_{i,} for at least one new production recipe ω_{j,} wherein the efficiency of said new production recipe ω_{j,} is greater than the efficiency of the current production recipe ω_{i,}.

7. A programmed computer system for improving a current production recipe, ω_{i,}, comprising at least one memory having at least one region storing computer executable program code and at least one processor for executing the program code stored in said memory, wherein the program code includes:
code to define a space of a plurality of production recipes, Ω;
code to define a distance, d, between two of said plurality of production recipes ω_{i,}ωⱼ∈Ω;
code to define an efficiency for at least one of said plurality of production recipes;
code to determine an optimal sampling distance, d*, from the current production recipe ω_{i,}; and
code to search at said optimal sampling distance d* from the current production recipe ω_{i,} for at least one new production recipe ω_{j,} wherein the efficiency of said new production recipe ω_{j,} is greater than the efficiency of the current production recipe ω_{i,}.
